(19) United States
(12) Patent Application Publication
(10) Pub. No.: US 2004/0003694 A1
(43) Pub. Date: Jan. 8, 2004

(54) Device and method for trimming and securing flexible tubes within a structure and articles made therefrom

(76) Inventors: Anthony Joseph Cesaroni, Gormley, CA (US); Gordon James Clarke, Markham, CT (US); Loung Phat Ly, Scarborough, CA (US); Kwai-Yung B. Su, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/421,554

(22) Filed: Apr. 23, 2003

Related U.S. Application Data
(60) Provisional application No. 60/376,644, filed on Apr. 30, 2002.

(51) Int. Cl. B26D 1/56; B23D 25/02

(52) U.S. Cl. 83/37; 83/869

(57) ABSTRACT

This invention relates to fabrication of tube bank style heat exchangers and similar assemblies. It provides a novel apparatus and a method for trimming polymeric tubes disposed within a core structure (such as a heat exchanger core) and securing these tubes within the core structure.

### CROSS REFERENCE TO RELATED APPLICATIONS

This application claims the benefit of U.S. Provisional Application No. 60/376,644, filed Apr. 30, 2002.

### FIELD OF THE INVENTION

This invention relates to devices used to trim and secure tubes within manufactured structures. More particularly this invention relates to such devices used in finishing operations to trim and bond flexible tubes inserted within structures such as heat exchanger cores and in which the tubes must be precisely secured relative to each other.

### BACKGROUND OF THE INVENTION

A variety of manufactured components contain tubing arranged in configurations suitable for their particular uses. For example, tubes are arranged and secured within harnesses or otherwise clamped together in desired arrangements for the transport of fluid (including both liquids and gases). Several illustrations of such configurations are found in vehicles, where power steering fluids and coolants and the like are delivered through tubing and hoses that must be precisely located and secured within the engine compartment. In these cases, the installation of the tubing is relatively straightforward and not particularly time-consuming.

However there are a multitude of more complex applications in which the article of manufacture contains a large number of tubes each of which must be precisely located and secured relative to the other. Another critical feature of such applications is that the tubes must be arranged in precise lengths when integrated into the article of manufacture. One such example is in a tube bank-style heat exchanger, in which individual tubes must be secured within appropriate fittings. Conventional approaches to the manufacture of such devices, and particularly those incorporating polymeric tubes that due to their flexibility pose significant challenges in precisely cutting the ends of the tubes and securing them as by welding operations, include manual assembly. It will be readily appreciated that this is very laborious and time consuming. And while automated techniques have been developed to cut and weld rigid tubes (such as metal tubes) into appropriate receptacles, these approaches are generally not suitable for the manipulation of flexible tubes in assemblies because their compliance is less predictable.

Moreover, cutting and welding operations place significant stresses on polymeric tubing. There is a significant potential for abrading or otherwise damaging the tubing, and such deleterious effects may not become evident until the article of manufacture is placed into service. Likewise, securing the tubes within a structure (as by welding) must be carefully conducted so as not to obstruct the internal surfaces of the tubing lengths. These considerations are considerably heightened in tube bank-style heat exchangers using polymeric tubing, where there are precise tolerances involved in positioning large numbers of small, flexible tubes within both a specific configuration and a compact design envelope. For example and depending on the application selected, tubes only 2 mm in diameter (or less) but having lengths of 2-3 feet (or more) might be arranged in a series of rows such that they are a mere 1-2 mm apart. In order to automate the process of trimming tube lengths and securing the tubes in a fixed receptacle, a dependable and repetitive technique must account for these and other technical challenges.

It is therefore an object of the present invention to provide a device suitable for the precise trimming of a plurality of flexible tubes in a core assembly, and thereafter securing them in place. Another object of the invention is to provide for such a device in conjunction with supporting apparatus to ensure that the core assembly containing the tubes is guided in a controlled manner through these operations. A feature of the present invention is that it can accommodate a number of tube shapes and core assembly designs. Another feature is that the device can be used with a wide variety of materials, and for example that polymeric tubing can be subjected to these operations along their surfaces without causing damage thereto. The invention offers several advantages, among them an automated process for the trimming and securing of flexible tubing into a core assembly such as a heat exchanger. These and other objects, features and advantages will become apparent upon having reference to the detailed description of the invention herein.

### SUMMARY OF THE INVENTION

There is disclosed and claimed herein apparatus for the trimming of polymeric tubes within a core structure and securing the tubes thereto. This apparatus comprises (a) cutting means adapted to trim a plurality of polymeric tubes along one or both ends thereof; (b) securing means adapted to secure the trimmed polymeric tubes to the core structure; and (c) support means adapted to position the core assembly relative to said cutting means and said securing means in a controlled manner for precise cutting and securing operations on the tubes therein.

Further, the apparatus of the invention can be incorporated into a process for the manufacture of core assemblies, like heat exchangers.

The invention will become better understood through a review of the following drawing thereof.

### BRIEF DESCRIPTION OF THE DRAWING

FIG. 1 is an exploded view of the apparatus of the present invention and illustrating its capacity to cut the tubing within a defined structure and secure the tubing within the structure as it moves therealong.

### DETAILED DESCRIPTION OF THE INVENTION

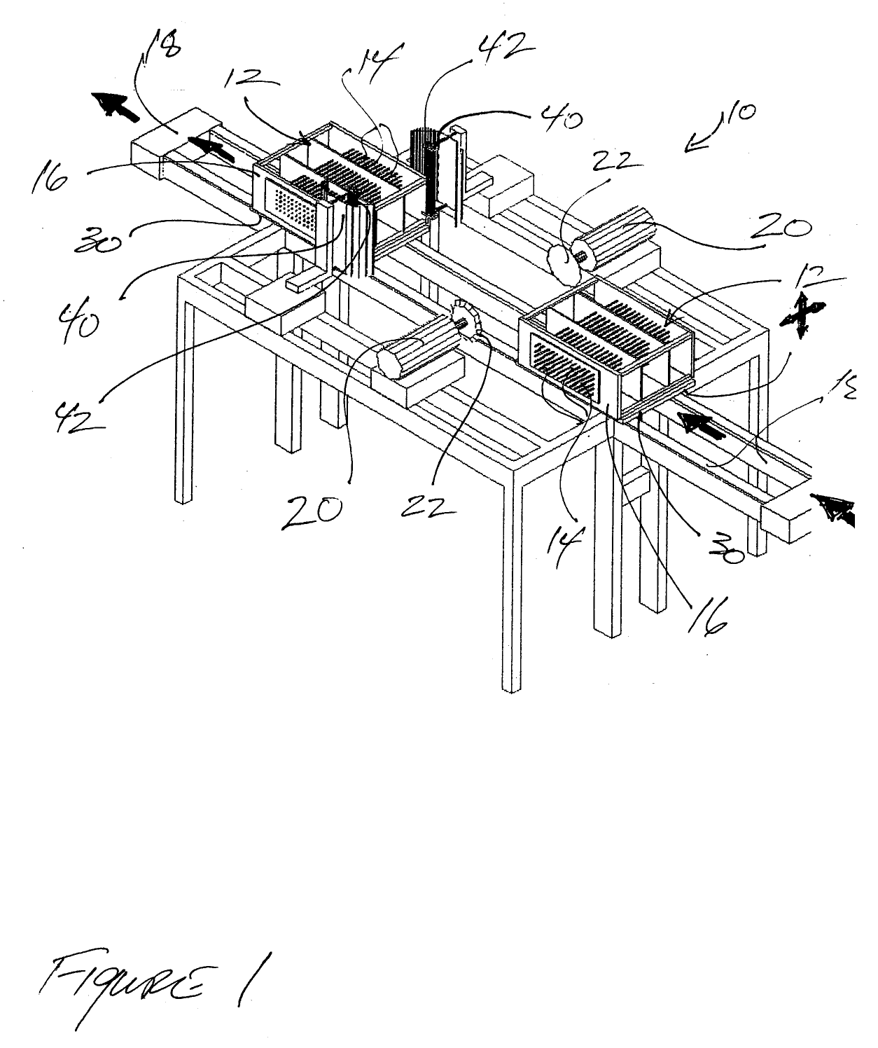

Having reference to FIG. 1, the apparatus of the invention is depicted generally at 10. It is seen that this apparatus includes cutting means 20, support means 30, and securing means 40, all positioned relative to each other to receive and process a core assembly 12.

The core assembly 12 includes polymeric tubes 14 disposed within a core structure 16. Depending on the technique used for the initial construction of the core assembly, the tubes 14 may extend beyond one or both sides of the core structure 16 after their insertion. This presents a problem, in that the core assembly 12 is typically designed to fit within a prescribed space and the polymeric tubes 14 in such event must not extend outside such a defined space. Moreover the polymeric tubes 14 as initially placed within the core assembly 12 are not sufficiently secured within the assembly.

The core assembly 12 is therefore presented for finishing operations, first by positioning it along a transport surface 18 (such as a smooth table or a conveyor belt with or without rollers). The core assembly 12 is positioned with the ends of the polymeric tubes 14 aligned generally perpendicular to the direction of movement along the transport surface 18. The core assembly 12 is then directed along the transport surface 16 and towards the cutting means 20 in the direction shown by the arrows.

The cutting means 20 is selected from any of a variety of designs that may be considered suitable for cutting the polymeric tubes 14 to a desired length and generally flush with the surface of the core structure 16. As depicted, two circular, surgical steel blades 22 are disposed on both sides of the core assembly 12. The blades 22 are operated by one or more motors (not shown) and can be adjusted to define particular cutting paths of interest. The blades 22 are further of sufficient diameter to cut all tubes presented along the transport surface 16.

The core assembly 12 including the polymeric tubes 14 which have been trimmed to exacting specifications by the cutting means 20 are next positioned within the securing means 40. The securing means 40 is selected from any of a variety of designs that may be considered suitable for securing the trimmed polymeric tubes 14 to the surface of the core structure 16. Examples of securing techniques suitable for adaptation for use herein include the use of lasers or hot pins, applied in a manner as is understood by those having skill in the art to which the invention pertains. Moreover the apparatus associated with the particular securing technique of interest in many instances may be readily mounted and interchanged at the welding station, a further attribute of the design of the assemblies contemplated herein. As depicted, IR welding apparatus 42 is disposed on both sides of the core assembly 12. The securing means 40 typically welds the polymeric tubes 14 to preselected positions along adjoining surfaces in the core structure 16. Moreover this welding is conducted in a manner suitable for the handling of polymeric tubes. In other words, a firm bond is created and the polymer itself is not degraded or otherwise compromised, so that it can withstand the rigors of its intended application.

The support means 30 is positioned to properly locate the core assembly 12 for both the trimming and securing operations. As shown, the support means 30 is located below the core assembly 12. Using any of a variety of motors and actuator means (not shown), the support means 30 can be moved up-down and left-right (as shown by the arrows), in a predetermined sequence to move the core assembly 12 into position for the trimming and securing operations.

The assembly of the instant invention can be used as a stand-alone operation in which core assemblies 12 are individually placed onto the transport means 18. Alternatively such assemblies can be used in conjunction with a larger apparatus used in a continuous mode operation. In such event the core assemblies 12 are mechanically routed to the apparatus described herein and similarly mechanically withdrawn once the operations described herein have been completed. The coordination of the operation of the various components described herein is central to the automated conditioning (eg trimming and securing) of the core assemblies, and can be tailored to particular manufacturing procedures using designs readily appreciated by those having skill in this field.

There are several variants on the basic assembly described herein that might be selected to suit a particular purpose. For example, either or both of the cutting means 20 and the securing means 40 may consist of only one blade 22 or one IR welding apparatus 42, respectively. This might be selected where the particular application in mind only requires cutting and/or welding on one side of the core assembly 12, for example. Alternatively, this configuration might be used in operations where one side or portion of the core assembly 12 is trimmed and welded, after which the core assembly 12 is manipulated to present another side or portion for the trim and weld operations. It is also readily appreciated that other apparatus might be designed into the system and intended to perform auxiliary functions, as necessary and selected by the designer.

There are several advantages associated with the assemblies and process of the present invention. It allows for the handling and automated finishing of relatively flexible tubes. It is very robust with coordinated moving parts including the cutting means 20 and the support means 30 operating near the securing means 40 (all under control of various motors and actuator assemblies). The device is thus easily adaptable in commercial production settings.

It is readily appreciated among those having skill in the art to which the invention pertains, that any number of modifications and variations can be made to the invention described herein. Such modifications and variations are contemplated as within the scope and spirit herein.

1. Apparatus for the trimming of polymeric tubes within a core structure and securing the tubes thereto comprising:
(a) Cutting means adapted to trim a plurality of polymeric tubes along one or both ends thereof;
(b) Securing means adapted to secure the trimmed polymeric tubes to the core structure; and
(c) Support means adapted to position the core assembly relative to said cutting means and said securing means in a controlled manner for precise cutting and securing operations on the tubes therein.

2. The apparatus of claim 1 wherein the core structure is a heat exchanger.

3. A process for the trimming and welding of polymeric tubes within a core structure comprising:
(a) Placing the core structure including the polymeric tubes on a transport mechanism;
(b) Transporting said core structure therealong to a cutting means;
(c) Contacting said cutting means to said core structure sufficient to trim a plurality of polymeric tubes along one or both ends thereof;
(d) Further transporting said core structure including the polymeric tubes to a securing means;
(e) Subjecting said core structure to said securing means such that the polymeric tubes are suitably bonded to said core structure; and
(f) Regulating the motion of said core structure relative to said cutting means and said securing means.

4. The process of claim 3 wherein said core structure is a heat exchanger.

5. An article of manufacture prepared according to the process of claim 3.
